(19) United States
(12) Patent Application Publication
(10) Pub. No.: US 2006/0028698 A1
(43) Pub. Date: Feb. 9, 2006

(54) AUTOMATIC DOCUMENT FEEDER SCANNER WITH A SCANNING MODULE CAPABLE OF POSITIONING ON AN ADF SCAN POSITION ACCURATELY

(76) Inventors: Yen-Cheng Chen, Hsin-Chu City (TW); Ruei-Jang Liou, Tai-Chung City (TW); Chung-Chih Luo, Changhua County (TW)

Correspondence Address: NORTH AMERICA INTELLECTUAL PROPERTY CORPORATION, P.O. BOX 506, MERRIFIELD, VA, 22116, US

(21) Appl. No.: 10/711,496

(22) Filed: Sep. 21, 2004

(30) Foreign Application Priority Data
Aug. 3, 2004 (TW) 093123277

(51) Int. Cl. H04N 1/04

(52) U.S. Cl. 358/498

(57) ABSTRACT

An automatic document feeder scanner includes a housing, an automatic document feeder, a predetermined pattern installed on a bottom surface of the automatic document feeder, a scanning module, and a processor capable of analyzing image data of the predetermined pattern and of determining a distance between the scanning module and an ADF scan position.

### BACKGROUND OF INVENTION

1. Field of the Invention

The present invention relates to a scanner, and more particularly, to an automatic document feeder (ADF) scanner having a scanning module capable of positioning on an ADF scan position accurately.

2. Description of the Prior Art

Generally, scanners can be cauterized into four types: barcode scanners, flatbed scanners, single sheet feeding scanners, and automatic document feeder (ADF) scanners.

A barcode scanner, as the name implies, is designed to capturing data of a bar code.

A flatbed scanner comprises a transparent document board for a document to be placed on, a scanning module for capturing data of the document placed on the transparent document board, and a processor for controlling the scanning module to move from a home position to a scan position, which is located under a first end of the transparent document board, and for controlling the scanning module to move from the scan position through the whole transparent document board to capture the data of the document.

A single sheet feeding scanner comprises a scanning module, a processor capable of controlling the scanning module to move from a home position to a scan position, and a sheet-feeding device controlled by the processor to convey a document. Unlike the processor of the flatbed scanner, which controls the scanning module to move from the scan position through the whole transparent document board to capture data of the document, the processor of the single sheet feeding scanner, however, controls the sheet-feeding device to convey the document to travel through the scanning module, which is located on the scan position, and controls the scanning module to capture the data of the document.

Concerning functionalities, an ADF scanner is composed of the flatbed scanner and the single sheet feeding scanner. Please refer to FIG. 1 and FIG. 2, which are two schematic diagrams of an ADF scanner 10 according to the prior art. The ADF scanner 10 comprises a housing 12, a transparent document board 14 installed on the housing 12 for a ready-to-be-scanned document 11 to be placed on (shown in FIG. 1), a document cover 16 installed on the housing 12 for covering the document 11 placed on the transparent document board 14, a processor 18 installed in the housing 12, a paper chute 26 mounted in front of an auto feeder hole 24 of the ADF 22 for as many as tens or even hundreds of documents 13 to be placed on (shown in FIG. 2), a document stacker 28 mounted in front of a document output hole (not shown) of the ADF 22 for collecting the document 13 output from the document output hole, a scanning module 20 installed in the housing 12 for capturing data of a document, such as the document 11 placed on the transparent document board 14 and the document 13 placed on the paper chute 26, and an detachable ADF 22 mounted on the housing 12 for conveying the document 13 placed on the paper chute 26 from the auto feeder hole 24, through the scanning module 20, to the document output hole with the help provided by a feeding roller.

The processor 18 of the ADF scanner 10 is installed to: (1) control the scanning module 20 to move from a home position HP to a scan position SSP, where is away from the home position HP by a first predetermined distance, and control the scanning module 20 to move from the scan position SSP through the whole transparent document board 14 to capture the data of the document 11 placed on the transparent document board 14; or (2) control the scanning module 20 to move from the home position HP to an ADF scan position ADFSSP, where is away from the home position HP by a second predetermined distance, control the ADF 22 to convey the document 13 placed on the paper chute 26 to travel from the auto feeder hole 24, through the ADF scan position ADFSSP, to the document output hole, and control the scanning module 20, which is located on the ADF scan position ADFSSP, to capture the data of the document 13.

It is apparent that the processor 18, in a process to control the scanning module 20 to move from the home position HP to either the scan position SSP or to the ADF scan position ADFSSP, only takes a predetermined distance (such as the first predetermined distance and the second predetermined distance), without considering other factors, such as relative position relations between the transparent document board 14 and the scan position SSP, and between the ADF 22 and the ADF scan position ADFSSP.

As described previously, the scanning module 20 has to be moved to the ADF scan position ADFSSP before capturing the document 13 placed on the paper chute 26. Ideally, the scanning module 20 located on the ADF scan position ADFSSP has the capability to capture the complete document 13, exactly from a page head to a page tail of the document 13. The page head of the document 13 conveyed by the ADF 22 is just passing through the scanning module 20 at the moment when the scanning module 20 starts to capture data.

However, due to errors resulting from a manufacturing process to manufacture the ADF 22 or from an installing process through which the ADF 22 can be installed on the housing 12, the head page of the document 13 conveyed by the ADF 22 still has a big chance to miss the scanning module 20 at the moment when the scanning module 20 starts to capture data, even if the scanning module 20 has already been moved to the ADF scan position ADFSSP accurately every time when starting to capture the data of the document 13 placed on the paper chute 26. In consequence, the scanning module 20 misses to capture the data of either the page head or the page tail of the document 13.

Moreover, since the ADF 22 is detachable and therefore can be detached from or installed on the housing 12, and the above-mentioned error resulting from the installing process through which the ADF 22 can be installed on the housing 12 is unavoidably increased with the increase of an installing number how many times the installing process has already been executed, the problem of the ADF scanner 10 that the page head of the document 13 conveyed by the ADF 22 cannot pass through the scanning module 20 at the moment when the scanning module 20 starts to capture data is getting worse with the increase of the installing number.

### SUMMARY OF INVENTION

It is therefore a primary objective of the claimed invention to provide an ADF scanner, whose scanning module is capable of positioning on an ADF scan position accurately, to solve the above-mentioned problems.

According to the claimed invention, the automatic document feeder scanner includes a housing, an automatic document feeder installed on the housing for conveying a first document, a first predetermined pattern installed on a bottom surface of the automatic document feeder, the first predetermined pattern having a first specific relative position relation with the first (ADF) scan position, a scanning module installed in the housing for capturing image data of the first document, and a processor installed in the housing for controlling the scanning module and the ADF, and for determining a distance between the scanning module and the first scan position by analyzing the image data of the first predetermined pattern captured by the scanning module.

According to the preferred embodiment, the scanning module, if controlled to move to the first scan position, can capture the whole first document.

It is an advantage of the claimed invention that an automatic document feeder scanner having the processor, the automatic document feeder, and the first predetermined pattern, which is installed on the bottom surface of automatic document feeder, can determine the first specific relative position relation between the scanning and the first scan position, and control the scanning module to move to the first scan position. Therefore, the automatic document feeder scanner can capture the whole first document conveyed over the automatic document feeder, without being interfered by errors resulting from a manufacturing process and an installing process.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 and FIG. 2 are two schematic diagrams of an ADF scanner according to the prior art.

FIG. 3 is a schematic diagram of an ADF scanner of the preferred embodiment according to the present invention.

FIG. 4 is a bottom view of an ADF of the ADF scanner shown in FIG. 3 according to the present invention.

FIG. 5 is an enlarged view of a predetermined pattern installed on a bottom surface of an ADF of a second embodiment according to the present invention.

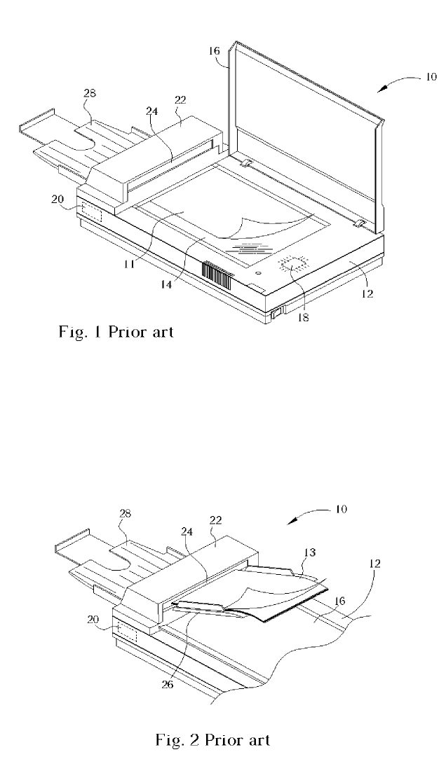

### DETAILED DESCRIPTION

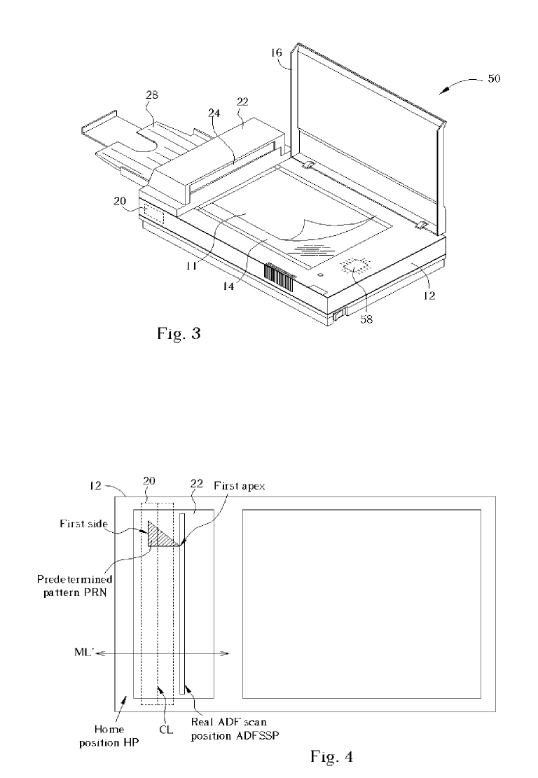

Please refer to FIG. 3, which is a schematic diagram of an ADF scanner 50 of the preferred embodiment according to the present invention. Like the ADF scanner 10, the ADF scanner 50 also comprises the housing 12, the transparent document board 14, the document cover 16, the scanning module 20, the detachable ADF 22, the paper chute 26, and the document stacker 28. However, the ADF scanner 50 does not include the processor 18, but a more powerful processor 58 instead. In addition to the capabilities that the processor 18 owns, such as controlling the operations of the scanning module 20 and the ADF 22, the processor 58 has other capabilities, which will be described in the following paragraphs. The processor 58 is installed in the housing 12.

In order to solve the problem that the scanning module 20 misses to capture the data of the page head (or page tail) of the document 13 due to the errors resulting from the manufacturing process and the installing process, a predetermined pattern PRN is installed on a bottom surface, which faces the scanning module 20, of the ADF 22 of the ADF scanner 50, and the processor 58 is capable of determining a relative position relation between the scanning module 20 and the ADF 22 and controlling the scanning module 20 to move to a real ADF scan position ADFSSPᵣₑₐₗ (the “other capabilities” of the processor 58) by controlling the scanning module 20 to move to any position under the predetermined pattern PRN and to capture image data of the predetermined pattern PRN in advance. What the scanning module 20 located on the real ADF scan position ADFSSPᵣₑₐₗ captures at the moment when starting to capture data are exactly the data of the page head of the document 13 conveyed by the ADF 22. In short, the predetermined pattern PRN has a first specific relative position relation with the real ADF scan position ADFSSPᵣₑₐₗ.

Please refer to FIG. 4, which is a bottom view of the ADF 22 of the preferred embodiment according to the present invention. The processor 58 controls the scanning module 20 to move back and forth along a moving line ML. The predetermined pattern PRN is a single solid isosceles right-angled triangle, which has a first side perpendicular to the moving line ML, and a first apex corresponding to the first side installed on a position (real ADF scan position ADFSSPᵣₑₐₗ) where the document 13 placed on the paper chute 26 is conveyed out from the ADF 22. The scanning module 20 has to be moved to the first apex to start to capture the complete document 13, including not only the page head, but the page tail as well.

How the processor 58 of the ADF scanner 50 controls the scanning module 20 to move to the real ADF scan position ADFSSPᵣₑₐₗ is described as follows: In the beginning, the processor 58 controls the scanning module 20 to move from the home position HP along the moving line ML to a position under the predetermined pattern PRN; The processor 58 then controls the scanning module 20 to capture the image data of the predetermined pattern PRN corresponding to the scanning module's 20 central line CL, where a light-sensing device of the scanning module 20, such as a charge-coupled device (CCD), is installed; The processor 58 measures a length of the captured image data, that is, a distance between two ending points of what the predetermined pattern PRN is captured by the scanning module 20 located on the position under the predetermined pattern PRN, and determines how far the scanning module 20 still has to be controlled to move to arrive on the real ADF scan position ADFSSPᵣₑₐₗ. Since the predetermined pattern PRN is a solid isosceles right-angled triangle, and the length of the captured image data (the distance between those two ending points) is equal to a distance from the captured image to the first apex, the processor 58, after measuring the length of the captured image data, still has to control the scanning module 20, which is located under the captured image data, to move the measured length farther; After controlling the scanning module 20 to move to the real ADF scan position ADFSSPᵣₑₐₗ, the processor 58 can then control the scanning module 20 to capture data. In such a scenario described above, no matter how severe the errors resulting from the manufacturing process and the installing process are, what the scanning module 20 captures at the moment when starting to capture data must be the data of the page head of the document 13.

The predetermined pattern PRN installed on the bottom surface of the ADF 22 described previously is a single solid isosceles right-angled triangle, whose first apex is located on the real ADF scan position ADFSSPᵣₑₐₗ. In an ADF scanner of the present invention, a predetermined pattern installed on a bottom surface of an ADF of the ADF scanner can have any number, such as more than one, of any type, such as solid or hollow, of any shape, such as a rectangle, a circle, and a line, and does not have to contact the real ADF scan position ADFSSPᵣₑₐₗ, like the predetermined pattern PRN does, as long as a length (solid predetermined pattern) or a distance between any two ending points of the captured image data of the predetermined pattern perpendicular to the moving line ML relate to the relative position relation between the captured image data and the real ADF scan position ADFSSPᵣₑₐₗ. Therefore, after measuring the length of the captured image data, the processor 58 can determines how far the scanning module 20 has to be controlled to move a distance from the captured image data to the first apex farther to arrive on the real ADF scan position ADFSSPᵣₑₐₗ.

Note that the predetermined pattern has to be installed on the bottom surface of the ADF 22 within a predetermined area, where the scanning module 20 moving along the moving line ML is capable of capturing any image data of the predetermined pattern, or the processor 58 cannot determine the relative position relation between the scanning module 20 and the real ADF scan position ADFSSPᵣₑₐₗ.

Of the ADF scanner 50, the processor 58 measures a length of any captured image data of the predetermined pattern PRN (in equivalent, the processor 58 analyzes the capture image data of the predetermined pattern PRN captured by the scanning module 20) and determines how far the scanning module 20 is located from the real ADF scan position ADFSSPᵣₑₐₗ. However, of an ADF scanner of the present invention, a processor still can determines the relative position relation between the scanning module 20 and the real ADF scan position ADFSSPᵣₑₐₗ through a mapping process on a predetermined pattern PRNCODE having a plurality of image codes CODE.

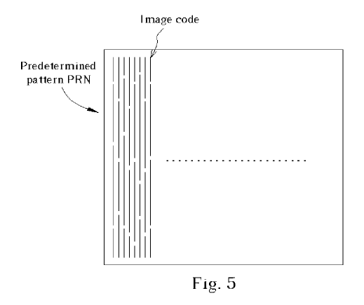

Please refer to FIG. 5, which is an enlarged view of the predetermined pattern PRNCODE, which is installed on the bottom surface of the ADF 22 of the second embodiment according to the present invention. According to the second embodiment, the ADF scanner 50, which comprises the ADF 22, further comprises a memory having a mapping table for mapping the image codes CODE onto a plurality of distances, whose length are different from each other. In equivalent, the mapping table stored in the memory maps an image data on any position of the predetermined pattern PRNCODE onto a specific length.

The predetermine pattern PRNCODE comprises a plurality of image codes CODE, all of which are perpendicular to the moving line ML. Unlike the processor 58 of the ADF scanner 50 shown in FIG. 4, which measures the length of the captured image data of the predetermined pattern PRN and determines the relative position relation between the scanning module 20 and the real ADF scan position ADFSSPᵣₑₐₗ, the processor 58 of the ADF scanner 50 shown in FIG. 5 determines the relative position relation between the scanning module 20 and the real ADF scan position ADFSSPᵣₑₐₗ through the mapping process on the predetermined pattern PRNCODE. In practice, the processor 58 maps an image code CODE on any position of the predetermined pattern PRNCODE captured by the scanning module 20 onto the mapping table and finds out a length corresponding to the captured image code CODE, and controls the scanning module 20 to move the length farther to arrive on the real ADF scan position ADFSSPᵣₑₐₗ.

In to the second embodiment, the image codes CODE are like a plurality of distinct secret codes stored in the predetermined pattern PRNCODE, so the processor 58, after decoding the secret codes, can controls the scanning module 20 to move farther a distance equal to a length that the secret code maps.

Since the predetermined pattern PRN (and the predetermined pattern PRNCODE as well) is not installed above the home position HP of the ADF scanner 50, the processor 58, as described previously, has to control the scanning module 20 to move from the home position HP to a position under the predetermined pattern PRN first, then controls the scanning module 20 to capture an image data of the predetermined pattern PRN on the position, and determines the relative position relation between the scanning module 20 and the real ADF scan position ADFSSPᵣₑₐₗ. However, in an ADF scanner of the present invention, a predetermined pattern PRN can be also installed on a position of the bottom surface of the ADF 22 right above the home position HP, and the processor 58 therefore, after the ADF scanner is powered on, can control the scanning module 20 to capture an image data of the predetermined pattern PRN facing the central line CL directly and immediately, and determine how far the scanning module 20 has to be controlled to move.

Equivalently, the ADF scanner 10 of the prior art takes the housing 12 as a reference coordinate, where an origin is the home position HP. The processor 18 controls the scanning module 20 to move from the home position HP to the ADF scan position ADFSSP away from the home position HP by a second predetermined distance, ignoring a relative position relation between the ADF 22 and the housing 12 and the relative position relation between the scanning module 20 and the real ADF scan position ADFSSPᵣₑₐₗ. No wonder the scanning module 20 of the ADF scanner 10 misses to capture the page head or the page tail of the document 13. On the contrary, the ADF scanner 50 of the present invention takes the ADF 22 as the reference coordinate, where a “floating” origin (the “floating” origin floats with the variation of the image data captured by the scanning module 20) is an image data of the predetermined pattern PRN facing the central line CL of the scanning module 20. The processor 58 controls the scanning module 20 to move from the “floating” origin by a distance having a specific length (how the specific length is determined has been described in detail previously, further description hereby omitted) to arrive on the real ADF scan position ADFSSPᵣₑₐₗ, and controls the scanning module 20 to capture the document 13. Therefore, no matter what the relative position relation between the ADF 22 and the housing 12 is, and no matter how severe the errors resulting from the manufacturing process and the installing process are, the processor 58 can always control the scanning module 20 to move to the real ADF scan position ADFSSPᵣₑₐₗ, and the scanning module 20 can always capture the complete document 13 accordingly, without missing to capture the page head or the page tail.

A mechanism to install the predetermined pattern PRN on the bottom surface of the ADF 22, as shown in FIG. 4 and FIG. 5, and determine the relative position relation between the scanning module 20 and real ADF scan position ADFSSPᵣₑₐₗ is disclosed here as an embodiment. Those skilled in the art will readily observe that numerous modifications and alterations of the ADF scanner may be made while retaining the teachings of the invention, as long as the processor of the ADF scanner has the capability to determine the relative position relation between the scanning module 20 and the ADF 22.

Not only having the capacity to capture the document 13, which is placed on the paper chute 26, the scanning module 20 of the ADF scanner 50 further has the capacity to capture the document 111 placed on the transparent document board 14, and the determining mechanism described previously to determine the relative position relation between the scanning module 20 and the ADF 22 can therefore be applied to determine a relative position relation between the scanning module 20 and the transparent document board 14. Similarly, the transparent document board 14 comprises a bottom surface and a predetermined pattern PRN₁ installed on the bottom surface. The predetermined pattern PRN₁ has a second specific relative position relation with a real scan position SSPᵣₑₐₗ, on which the scanning module 20 can capture the whole document 111 placed on the transparent document board 14. The processor 58 further has a capability to analyze determine image data of the predetermined pattern PRN₁ on any position captured by the scanning module 20 and determine how far the scanning module 20 is from the real scan position SSPᵣₑₐₗ. After determining the real scan position SSPᵣₑₐₗ, the processor 58 controls the scanning module 20 to move to the real scan position SSPᵣₑₐₗ, instead of the scan position SSP of the ADF scanner 10 of the prior art.

In contrast to the prior art, the present invention can provide an ADF scanner comprising a housing, a processor, a scanning module, an ADF, and a predetermined pattern installed on a bottom surface of the ADF. The processor has a capability to analyze the predetermined pattern and controls the scanning module to move. Therefore, the scanning module can acquire all the data of a ready-to-be-scanned document, without the worry about how severe the errors resulting from a manufacturing process and an installing process are.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic document feeder (ADF) scanner having a scanning module capable of positioning on a first scan position accurately, the automatic document feeder scanner comprising:
a housing;
an automatic document feeder installed on the housing for conveying a first document;
a first predetermined pattern installed on a bottom surface of the automatic document feeder, the first predetermined pattern having a first specific relative position relation with the first scan position;
a scanning module installed in the housing for capturing image data of the first document; and
a processor installed in the housing for controlling the scanning module and the ADF, and for determining a distance between the scanning module and the first scan position by analyzing the image data of the first predetermined pattern captured by the scanning module.

2. The automatic document feeder scanner of claim 1, wherein the scanning module positioned on the first scan position is capable of capturing the whole first document conveyed over the automatic document feeder.

3. The automatic document feeder scanner of claim 1, wherein the first predetermined pattern is an isosceles right-angled triangle, which has a first side perpendicular to a moving line along which the scanning module is passing, and an apex corresponding to the first side, the apex having the first specific relative position relation with the first scan position.

4. The automatic document feeder scanner of claim 3, wherein the isosceles right-angled triangle is solid, the processor determining the distance between the scanning module and the first scan position by measuring a length of the first predetermined pattern captured by the scanning module.

5. The automatic document feeder scanner of claim 3, wherein the isosceles right-angled triangle is hollow, the processor determining the distance between the scanning module and the first scan position by measuring a distance between two ending points of the first predetermined pattern captured by the scanning module.

6. The automatic document feeder scanner of claim 1, wherein the processor is capable of controlling the scanning module to move from a home position to the first scan position, and the first predetermined pattern is installed on an area of the bottom surface of the automatic document feeder where the scanning module while moving from the home position to the first scan position can capture the first predetermined pattern.

7. The automatic document feeder scanner of claim 1 further comprising a memory for storing a mapping table to map an image data of the first predetermined pattern to a length, the processor mapping an image data of the first predetermined pattern captured by the scanning module onto the mapping table and finding out a length corresponding to the captured image data, and determining the distance between the scanning module and the first scan position.

8. The automatic document feeder scanner of claim 1 further comprising a transparent document board for a second document to be placed on, and a second predetermined pattern installed on a bottom surface of the transparent document board, the second predetermined pattern having a second specific relative position relation with a second scan position, on which the scanning module can capture the whole second document, and the processor further comprising a capability to determine a distance between the scanning module and the second scan position by analyzing an image data of the second predetermined pattern captured by the scanning module.

9. An automatic document feeder scanner having a scanning module capable of positioning on a first scan position accurately, the automatic document feeder scanner comprising:
a housing;
an automatic document feeder installed on the housing for conveying a first document, the automatic document feeder having a bottom surface and a first predetermined pattern installed on the bottom surface;
a first predetermined pattern installed on a bottom surface of the automatic document feeder, the first predetermined pattern having a first specific relative position relation with the first scan position;
a scanning module installed in the housing for capturing image data of the first document;
a memory installed in the housing for storing a first mapping table, which maps image data of the first predetermined pattern captured by the scanning module onto a variety of first length; and
a processor installed in the housing for controlling the scanning module and the ADF, and for finding out a first length corresponding to the captured image data in the mapping table according to the captured image data of the first predetermined pattern captured by the scanning module, and determining the distance between the scanning module and the first scan position according to the found first length.

10. The automatic document feeder scanner of claim 9, wherein the scanning module positioned on the first scan position can capture the whole first document conveyed over the automatic document feeder.

11. The automatic document feeder scanner of claim 9, wherein the processor is capable of controlling the scanning module to move from a home position to the first scan position, and the first predetermined pattern is installed on an area of the bottom surface of the automatic document feeder where the scanning module while moving from the home position to the first scan position can capture the first predetermined pattern.

12. The automatic document feeder scanner of claim 9 further comprising a transparent document board for a second document to be placed on, a second predetermined pattern installed on a bottom surface of the transparent document board, and a second mapping table stored in the memory for mapping image data of the second predetermined pattern captured by the scanning module onto a variety of second length, and the processor further comprising a capability to find out a second length corresponding to the image data of the second predetermined pattern captured by the scanning module in the second mapping table and determine a distance between the scanning module and a second scan position corresponding to the transparent document board according to the second length.

13. An automatic document feeder scanner comprising:
a housing;
an automatic document feeder installed on the housing for conveying a document;
a scanning module installed in the housing for capturing image data of the document;
a position detector installed in the housing for detecting a relative position relation between the automatic module document feeder and where the scanning module is located in the housing; and
a processor installed in the housing for controlling the movement of the scanning module according to the relative position relation between the automatic document feeder and where the scanning module is located in the housing, and for controlling the scanning module to capture the image data of the document conveyed over the automatic document feeder.
